(19) United States
(12) Patent Application Publication
(10) Pub. No.: US 2007/0087757 A1
(43) Pub. Date: Apr. 19, 2007

(54) Method and system for balancing load in a multi-band system

(76) Inventors: Ronald Scott Core, Cave Creek, AZ (US); Kent M. Conness, Downers Grove, IL (US); Kris K. Martinovich, Streamwood, IL (US)

Correspondence Address: MOTOROLA, INC., LAW DEPARTMENT, 1303 E. ALGONQUIN ROAD, SCHAUMBURG, IL, 60196, US

(21) Appl. No.: 11/250,801

(22) Filed: Oct. 13, 2005

(51) Int. Cl. H04Q 7/20

(52) U.S. Cl. 455/453

(57) ABSTRACT

A method and system for balancing load in a multi-band cellular network (100) is disclosed. The method includes generating a candidate carrier list (208) at a communication device (108). The candidate carrier list comprises carriers from at least two bands in the multi-band cellular network. The method further includes selecting a band through a carrier selection from the candidate carrier list. A carrier is selected from carriers in the band. The communication device then connects to the carrier.

### RELATED APPLICATIONS

Related subject matter is disclosed in U.S. patent application entitled “METHOD AND SYSTEM FOR BALANCING LOAD ACROSS CARRIER SEAMS IN A MULTI-BAND SYSTEM” having application Ser. No. ______ and filed on the same date herewith and assigned to the same assignee.

### BACKGROUND OF THE INVENTION

Nowadays, cellular networks are rapidly changing with increased mobility of communication devices. The communication devices themselves are multi-featured and assist users in daily activities. Further, communication devices can now operate in multi-band cellular networks. Examples of bands in a multi-band cellular network include the 800 MHz Code Division Multiple Access (CDMA) band in the United States, the 800 MHz CDMA band in Japan, the 2.1 GHz CDMA band, and the 1900 MHz Personal Communications Service (PCS) band. Network load is increased due to the increased number of communication devices across the multi-bands cellular networks. Load balancing is required to uniformly distribute the network load across all the bands in multi-band cellular networks.

In multi-band cellular networks, communication devices acquire carriers in different frequency bands. A carrier in a particular band corresponds to a particular frequency on which a communication device works. By default, current communication devices connect to a particular band. This band can get overloaded, while other bands remain under-utilized.

In a known method for load balancing, when a communication device is switched on, it connects to a carrier in a default band. In case the band gets congested, a message is sent to the communication device to try connecting to another band. However, the message is sent only when the band is already overloaded. The overloading can lead to failures in connection of calls and disconnection of active calls. Further, in current multi-band cellular networks, load distribution is achieved only at the infrastructure systems. Therefore, any changes in the methodology for load balancing require a change in the software at all infrastructure system. Furthermore, load balancing at the infrastructure systems can impact large amounts of communication devices thereby causing congestion on a target band.

### BRIEF DESCRIPTION OF THE DRAWINGS

The present invention is illustrated by way of example and not limitation in the accompanying figures, in which like references indicate similar elements, and in which:

FIG. 1 representatively illustrates a block diagram of a multi-band cellular network, in accordance with an exemplary embodiment of the present invention.

FIG. 2 representatively illustrates a block diagram of a communication device, in accordance with another exemplary embodiment of the present invention.

FIG. 3 representatively illustrates a block diagram of a communication device sub-system performing hash operation for selecting a carrier, in accordance with yet another exemplary embodiment of the present invention.

FIG. 4 representatively illustrates a flowchart depicting a method for balancing load in a multi-band cellular network, in accordance with an exemplary embodiment of the present invention.

FIG. 5 representatively illustrates a flowchart depicting a method for balancing load in a multi-band cellular network, in accordance with another exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail the particular method and system for balancing load in a multi-band system in accordance with the present invention, it should be observed that the present invention resides primarily in combinations of method steps and apparatus components related to method and system for balancing load in a multi-band system. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

In accordance with an embodiment of the present invention, a communication device capable of operation in a multi-band system is disclosed. The communication device includes a memory, a hashing module and a processor. The memory stores a candidate carrier list. The candidate carrier list includes carriers from at least two bands in the multi-band system. The hashing module performs at least one hash operation on a communication device specific property using the candidate carrier list stored in the memory. The processor then selects a carrier from the candidate carrier list based on the output of the at least one hash operation.

In accordance with another embodiment of the present invention, a method for balancing load in a multi-band system is disclosed. To balance load in the multi-band system, a candidate carrier list is generated at a communication device. The candidate carrier list includes carriers from at least two bands in the multi-band system. After the candidate carrier list is generated, a band is selected through a carrier selection from the candidate carrier list. Further, the communication device is connected to a carrier from the band.

In accordance with yet another embodiment of the present invention, a method for balancing load in a multi-band system is disclosed. The method includes generating a candidate carrier list at a communication device wherein the candidate carrier list is generated from at least two bands in the multi-band system. A plurality of hash operations are performed on a communication device specific property. A band is selected through a carrier selection from the candidate carrier list based on the plurality of hash operations. The communication device is connected to a carrier from the selected band.

FIG. 1 representatively illustrates a block diagram of a multi-band cellular network 100, in accordance with an exemplary embodiment of the present invention. The multi-band cellular network 100 includes at least two bands, for example, a band 102, a band 104 and a band 106 to which a communication device 108 can connect. The multi-band cellular network 100 can also comprise other bands to which the communication device 108 cannot connect. The communication device 108 communicates through the plurality of bands in the multi-band cellular network 100. Each band includes a plurality of carriers. A carrier in a band corresponds to a frequency on which a communication device receives and transmits data. As shown in FIG. 1, the band 102 has two carriers, the band 104 has two carriers, and the band 106 has five carriers. The communication device 108 can request each band to provide a list of carriers that are available in the band.

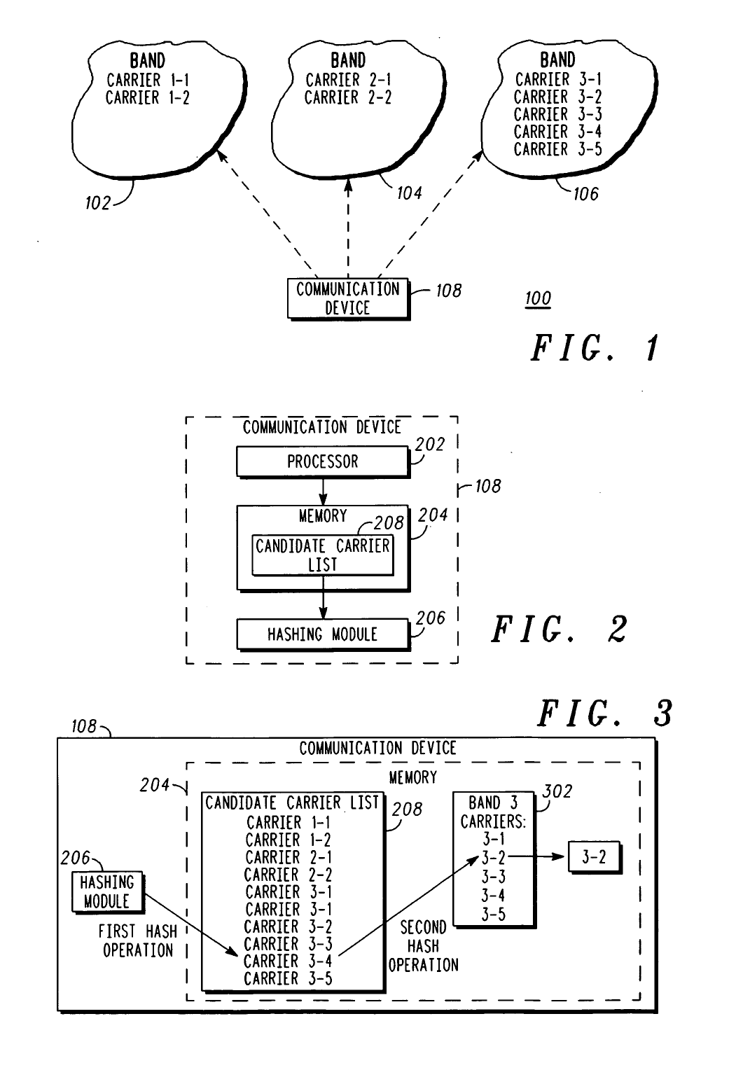

FIG. 2 representatively illustrates a block diagram of a communication device 108, in accordance with another exemplary embodiment of the present invention. The communication device 108 communicates in the multi-band cellular network 100. The communication device 108 supports all bands in the multi-band cellular network 100. The communication device 108 includes a processor 202, a memory 204 and a hashing module 206. On obtaining lists of carriers from each of the bands in the communication network 100, the communication device 108 can create a candidate carrier list 208. The candidate carrier list 208 comprises all carriers available for the at least two bands in the multi-band cellular network 100. Therefore, the candidate carrier list 208 generated by the communication device 108 includes the carriers available with the bands 102, 104, and 106. The memory 204 stores the candidate carrier list 208. The hashing module 206 can perform a plurality of hash operations which generates random numbers. The plurality of hash operations is performed on a communication device specific property. Based on the plurality of hash operations, a carrier is selected from the candidate carrier list 208. Examples of the communication device specific property include, but are not limited to, an Electronic Serial Number (ESN), an International Mobile Subscriber Identity (IMSI), an International Mobile Equipment Identity (IMEI) number and a Mobile Identification Number (MIN).

The processor 202 directs the communication device 108 to connect to the carrier selected based on the result of the hashing module 206. The processor 202 can be a microprocessor or an ASIC (Application Specific Integrated Circuit) embedded in the communication device 102.

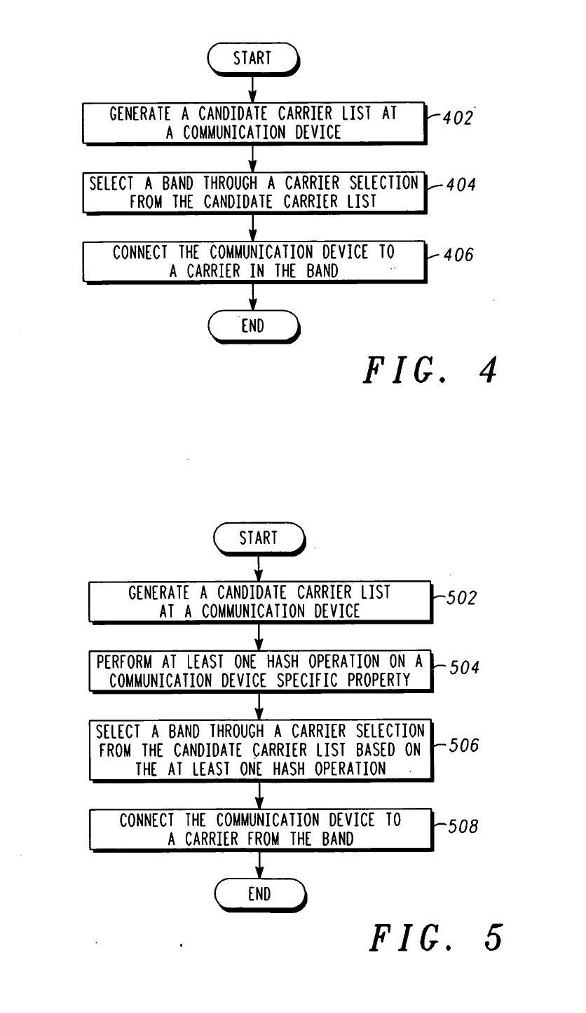

FIG. 3 representatively illustrates a block diagram showing the selection of a final carrier 302, in accordance with an exemplary embodiment of the present invention. The communication device 108 stores the candidate carrier list 208 in the memory 204. The hashing module 206 performs a first hash operation over the candidate carrier list 208 the result of which is a carrier 3-4 in band 106. An exemplary hash operation is described in a CDMA2000 standards documentation titled ‘Upper Layer (Layer 3) Signaling Standard for cdma2000 Spread Spectrum Systems’s, release D, published by the Third Generation Partnership Project 2(3GPP2), on page 2-621. The hashing module 206 performs a second hash operation over the carriers list for the band 106 which results in the selection of the final carrier 302. The communication device 108 then connects and starts communication through the final carrier 302.

FIG. 4 representatively illustrates a flowchart depicting a method for balancing load in a multi-band cellular network, in accordance with an exemplary embodiment of the present invention. At step 402, a candidate carrier list is generated at a communication device. The candidate carrier list comprises carriers from at least two bands in the multi-band cellular network. In an embodiment of the invention, the list of carriers that form a part of the candidate carrier list are obtained from the at least two bands in the multi-band communication network. At step 404, a band is selected through a carrier selection from the candidate carrier list. In accordance with an embodiment of the invention, the carrier selection process comprises performing a first hash operation on a communication device specific property. Examples of the communication device specific property include, but are not limited to, an Electronic Serial Number (ESN), an International Mobile Subscriber Identity (IMSI), an International Mobile Equipment Identity (IMEI) number and a Mobile Identification Number (MIN). An exemplary hash operation is described in a CDMA2000 standards documentation titled ‘Upper Layer (Layer 3) Signaling Standard for cdma2000 Spread Spectrum Systems’s, release D, published by the Third Generation Partnership Project 2 (3GPP2), on page 2-621. At step 406, the communication device connects to a carrier selected from the band selected at step 404. In an embodiment of the present invention, the carrier to which the communication device connects is selected by performing a second hash operation on the communication device specific property to select the carrier from the carriers obtained from the band that is selected at step 404. The second hash operation can be similar to the first hash operation. However, the second hash operation selects a carrier from the carriers obtained from the selected band, while the first hash operation selects a band from all the carriers to which the communication device can connect.

FIG. 5 representatively illustrates a flowchart depicting a method for balancing load in a multi-band cellular network, in accordance with another exemplary embodiment of the present invention. At step 502, a candidate carrier list is generated at a communication device. The candidate carrier list comprises carriers from at least two bands in the multi-band cellular network. In an embodiment of the invention, the list of carriers that form a part of the candidate carrier list are obtained from the at least two bands in the multi-band communication network. At step 504, at least one hash operation is performed on a communication device specific property. At step 506, a band is selected through a carrier selection from the candidate carrier list based on the results of a first hash operation. At step 508, the communication device connects to a carrier selected from the band selected at step 506. In an embodiment of the invention, the carrier to which the communication device connects is selected using a second hash operation. Both the hash operations can be existing carrier selection processes.

Various embodiments of the present invention provide load balancing in multi-band networks and offer many advantages. The communication device specific property is unique for every device. The result of the hash operation of the communication device specific property randomly selects the band, and subsequently the carrier, to which the communication device connects. Since this selection can be from any of the bands in the multi-band communication network, and not just from a default band to which the device connects, the load in the multi-band communication network is more evenly balanced. Further, various embodiments of the present invention can be implemented at the communication device. Therefore, no changes are required from at the infrastructure of the multi-band communication network. The changes in the communication device are also minimal, since existing carrier selection processes can be used while expanding the list of carriers from which the selection is made.

It will be appreciated that the method and communication device for balancing load in a multi-band system described herein may be comprised of one or more conventional processors and unique stored program instructions that control the one or more processors to implement, in conjunction with certain non-processor circuits, some, most, or all of the functions of the method and system described herein. The non-processor circuits may include, but are not limited to, a radio receiver, a radio transmitter, signal drivers, clock circuits, power source circuits, and user input devices. As such, these functions may be interpreted as steps of a method to balance loads in a multi-band communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for balancing load in a multi-band system, wherein each band of the multi-band system comprises at least one carrier, the method comprising:
generating a candidate carrier list at a communication device, the candidate carrier list comprising carriers from at least two bands in the multi-band system;
selecting a band through a carrier selection from the candidate carrier list; and
connecting the communication device to a carrier from the band.

2. The method of claim 1 wherein generating the candidate carrier list comprises obtaining carrier lists from at least two bands in the multi-band system.

3. The method of claim 1 further comprising selecting the band from the multi-band system utilizing the candidate carrier list and a communication device specific property.

4. The method of claim 3, wherein selecting the band comprises performing a first hash operation on the communication device specific property.

5. The method of claim 4, wherein performing the first hash operation comprises executing an existing carrier selection process over the candidate carrier list.

6. The method of claim 1, wherein connecting the communication device to the carrier in the band comprises performing a second hash operation on the communication device specific property.

7. The method of claim 6, wherein performing the second hash operation comprises executing an existing carrier selection process over carriers from the band.

8. The method of claim 3, wherein the communication device specific property is selected from a group comprising an Electronic Serial Number (ESN), an International Mobile Subscriber Identity (IMSI), an International Mobile Equipment Identity (IMEI) number and a Mobile Identification Number(MIN).

9. A method for balancing load in a multi-band system, wherein each band of the multi-band system comprises at least one carrier, the method comprising:
generating a candidate carrier list at a communication device, the candidate carrier list comprising carriers from at least two bands in the multi-band system;
performing at least one hash operation on a communication device specific property;
selecting a band through a carrier selection from the candidate carrier list based on the at least one hash operation; and
connecting the communication device to a carrier from the band.

10. The method of claim 9 wherein generating the candidate carrier list comprises obtaining carrier lists from the at least two bands in the multi-band system.

11. The method of claim 9, wherein performing the at least one hash operation comprises:
performing a first hash operation on the communication device specific property to select the band; and
performing a second hash operation on the communication device specific property to select the carrier from the band.

12. The method of claim 11, wherein performing the first hash operation comprises executing an existing carrier selection process over the candidate carrier list.

13. The method of claim 11, wherein performing the second hash operation comprises executing an existing carrier selection process over carriers from the band.

14. The method of claim 9, wherein the communication device specific property is selected from a group comprising an Electronic Serial Number (ESN), an International Mobile Subscriber Identity (IMSI), an International Mobile Equipment Identity (IMEI) number and a Mobile Identification Number(MIN).

15. A communication device capable of operation in a multi-band system, wherein each band of the multi-band system comprises at least one carrier, the communication device comprising:
a memory storing a candidate carrier list, the candidate carrier list comprising carriers from at least two bands in the multi-band system;
a hashing module, the hashing module performing at least one hash operation on a communication device specific property; and
a processor selecting a carrier from the candidate carrier list based on the at least one hash operation.

16. The communication device of claim 15, wherein the communication device specific property is selected from a group comprising an Electronic Serial Number (ESN), an International Mobile Subscriber Identity (IMSI), an International Mobile Equipment Identity (IMEI) number and a Mobile Identification Number (MIN).
